(19) United States
(12) Patent Application Publication
(10) Pub. No.: US 2014/0343935 A1
(43) Pub. Date: Nov. 20, 2014

(54) APPARATUS AND METHOD FOR PERFORMING ASYNCHRONOUS SPEECH RECOGNITION USING MULTIPLE MICROPHONES

(71) Applicant: ELECTRONICS AND TELECOMMUNICATIONS RESEARCH INSTITUTE, Daejeon-city (KR)

(72) Inventors: Ho-Young JUNG, Daejeon (KR); Ki-Young PARK, Daejeon (KR); Jeom-Ja KANG, Daejeon (KR); Yun-Keun LEE, Daejeon (KR)

(73) Assignee: ELECTRONICS AND TELECOMMUNICATIONS RESEARCH INSTITUTE, Daejeon-city (KR)

(21) Appl. No.: 14/277,241

(22) Filed: May 14, 2014

(30) Foreign Application Priority Data
May 16, 2013 (KR) 10-2013-0055421

(51) Int. Cl. G10L 15/20

(52) U.S. Cl. CPC G10L 15/20
USPC 704/233

(57) ABSTRACT

An apparatus and method for performing asynchronous speech recognition using multiple microphones are disclosed. The apparatus includes a microphone selection unit, a signal-to-noise ratio measurement unit, a speech recognition and verification unit, and a final recognition result output unit. The microphone selection unit selects two or more microphones responsive to a user's voice from among a plurality of microphones distributed around the user. The signal-to-noise ratio measurement unit measures the signal to noise ratios of inputs of the selected two or more microphones. The speech recognition and verification unit performs speech recognition using the input of the microphone having a highest signal to noise ratio, and verifies the speech recognition using the inputs of the remaining microphones. The final recognition result output unit outputs the final recognition results of the user's voice based on the results of the speech recognition and verification unit.

### CROSS REFERENCE TO RELATED APPLICATION

This application claims the benefit of Korean Patent Application No. 10-2013-0055421, filed on May 16, 2013, which is hereby incorporated by reference herein in its entirety.

### BACKGROUND OF THE INVENTION

1. Technical Field

The present disclosure relates to an apparatus and method for performing asynchronous speech recognition using multiple microphones and, more particularly, to an apparatus and method that are capable of improving the performance of speech recognition using a plurality of microphones in a long distance speech recognition environment in which background noises are present.

2. Description of the Related Art

When long distance speech recognition is performed in an environment in which various noises are present, it is difficult to achieve desired recognition performance using only a single microphone.

In order to overcome this problem, a conventional method of arranging multiple microphones in a specific structure, thereby eliminating noise and also performing speech recognition was developed.

The above conventional method is disadvantageous in that performance is limited by the number and locations of noises. This conventional method exhibits desired performance only when predetermined conditions are met. Otherwise this conventional method does not sufficiently eliminate noises. Rather, it generates distortion attributable to the elimination of noises. Accordingly, it is limited in improvement in the performance of speech recognition.

As a related preceding technology, Korean Patent No. 0855592 entitled “Speech Recognition Apparatus and Method Robust to Utterer Distance Characteristic” discloses a technology that is capable of improving both long distance speech recognition performance and short distance speech recognition performance and being robust to external noises.

The speech recognition apparatus disclosed in Korean Patent No. 0855592 includes a distance-based speech recording unit configured to simultaneously receive and record voices input via a short distance speech recording unit and a long distance speech recording unit; an external noise elimination unit configured to receive distance-based voices output by the distance-based speech recording unit, to estimate external noises, and to eliminate the estimated external noises from the recorded voices; an input voice selection unit configured to receive external noise-free recorded voices from the external noise elimination unit, to identify a voice capable of improving the performance of speech recognition among the input voices into which the distance characteristics of long and short distances have been incorporated; and a speech recognition unit configured to receive the voice selected by the input voice selection unit, and to then perform speech recognition.

The technology disclosed in Korean Patent No. 0855592 above-described is configured such that the speech recognition apparatus is equipped with a short distance microphone and a long distance microphone, receives a user's voice, selects a distance, and performs speech recognition.

As another related preceding technology, Korean Patent No. 0905586 entitled “System and Method for Evaluating Performance of Microphones for Long Distance Speech Recognition in Robot” discloses a technology for enabling the degree of voice attenuation or the degree of voice distortion or both to be measured over a long distance.

The system for evaluating the performance of microphones for long distance speech recognition in a robot, which is disclosed in Korean Patent No. 0905586, includes a reference voice database configured to store voice signals required to evaluate the performance of at least two or more microphones; a measured value calculation unit configured to, when a voice signal from the reference voice database is input to the reference and target microphones of the microphones, measure and quantify at least one of the attenuation and distortion of the voice signal input in response to the selection of a performance evaluation criterion; a comparison unit configured to compare the measured result quantified by the measured value calculation unit with a reference value; and a microphone selection unit configured to determine whether to select the target microphone based on the results of the comparison.

The technology disclosed in Korean Patent No. 0905586 is configured to select a microphone highly responsive to a user's voice using microphones at various distances and to then perform speech recognition.

In summary, the above-described related technologies are configured to be equipped with a short distance microphone and a long distance microphone, select one from among them and then perform speech recognition, or to select one from among multiple microphones and then perform speech recognition using the selected microphone.

The above-described related technologies do not perform collaborative speech recognition using multiple microphones responsive to a user's voice regardless of distance.

### SUMMARY OF THE INVENTION

At least one embodiment of the present invention is intended to provide an apparatus and method for performing asynchronous speech recognition using multiple microphones, in which, in a long distance speech recognition environment in which background noise varies in a variety of manners, multiple microphones are distributed and microphones responsive to a user's voice are selected from among the multiple microphones and used for speech recognition, thereby improving the performance of speech recognition.

In accordance with an aspect of the present invention, there is provided an apparatus for performing asynchronous speech recognition using multiple microphones, the apparatus including a microphone selection unit configured to select two or more microphones responsive to a user's voice from among a plurality of microphones distributed around the user; a signal-to-noise ratio measurement unit configured to measure the signal to noise ratios of inputs of the selected two or more microphones; a speech recognition and verification unit configured to perform speech recognition using the input of the microphone which belongs to the selected two or more microphones and whose signal to noise ratio is highest, and to verify the speech recognition using the inputs of the remaining microphones; and a final recognition result output unit configured to output the final recognition results of the user's voice based on the results of the speech recognition and verification unit.

The speech recognition and verification unit may include a speech recognition unit configured to perform the speech recognition of the input of the microphone having the highest signal to noise ratio, and to output one or more word candidates and probability values of the word candidates for each time span as results of the speech recognition; and a reliability measurement unit configured to measure the reliabilities of the one or more word candidates for each time span using the inputs of the remaining microphones.

The final recognition result output unit may determine the final scores of the one or more word candidates for the time span based on the probability values and reliabilities of the one or more word candidates for the time span, and may output a word candidate having a highest value for the time span as one of the final recognition results.

The apparatus may further include a noise processing unit configured to perform noise processing on the inputs of the selected two or more microphones.

The noise processing unit may include a Wiener filter.

In accordance with another aspect of the present invention, there is provided a method of performing asynchronous speech recognition using multiple microphones, the method including selecting, by a microphone selection unit, two or more microphones responsive to a user's voice from among a plurality of microphones distributed around the user; measuring, by a signal-to-noise ratio measurement unit, the signal to noise ratios of the inputs of the selected two or more microphones; performing, by a speech recognition and verification unit, speech recognition using the input of the microphone which belongs to the selected two or more microphones and whose signal to noise ratio is highest, and verifying, by the speech recognition and verification unit, the speech recognition using the inputs of the remaining microphones; and outputting, by a final recognition result output unit, the final recognition results of the user's voice based on the results of the speech recognition and verification unit.

Performing the speech recognition and verifying the speech recognition may include performing the speech recognition of the input of the microphone having the highest signal to noise ratio, and outputting one or more word candidates and the probability values of the word candidates for each time span as the results of the speech recognition; and measuring the reliabilities of the one or more word candidates for each time span using the inputs of the remaining microphones.

Outputting the final recognition results may include determining the final scores of the one or more word candidates for the time span based on the probability values and reliabilities of the one or more word candidates for the time span, and outputting a word candidate having a highest value for the time span as one of the final recognition results.

The method may further include performing, by a noise processing unit, noise processing on the inputs of the selected two or more microphones.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram of a configuration of an apparatus for performing asynchronous speech recognition using multiple microphones according to an embodiment of the present invention;

FIG. 2 is a diagram of an example of an arrangement in which a plurality of microphones is distributed and microphones which are responsive to a user's voice;

FIG. 3 is a flowchart of a method of performing asynchronous speech recognition using a plurality of microphones according to an embodiment of the present invention; and

FIG. 4 is a diagram of an example of a word lattice and a final recognition result that are used in the description of embodiments of the present invention.

### DESCRIPTION OF THE PREFERRED EMBODIMENTS

An apparatus and method for performing asynchronous speech recognition using multiple microphones according to embodiments of the present invention are described below with reference to the accompanying drawings. Prior to the following detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the embodiments and the configurations at the time at which the present application is filed.

It is very difficult to perform long distance speech recognition in an environment in which multiple noises are present because a user's voice (i.e., a recognition target) is contaminated with background noise in a variety of manners. Conventional technologies include a method of arranging multiple microphones in a specific structure, estimating the direction of a user and receiving a signal from the estimated direction, and a method of separating a user's voice and noises. The method of estimating the direction of a user is problematic in that performance is poor in an environment in which there is an echo, and the method of separating a voice and noises is problematic in that desirable performance can be achieved only when the number of noises is determined in advance. Furthermore, the two conventional methods all have the problem of causing distortion while eliminating noises.

The present invention is configured to distribute N microphones around a user, to select a few microphones responsive to a user's voice, to perform recognition and verification on the voices of the selected microphones, and to output final recognition results.

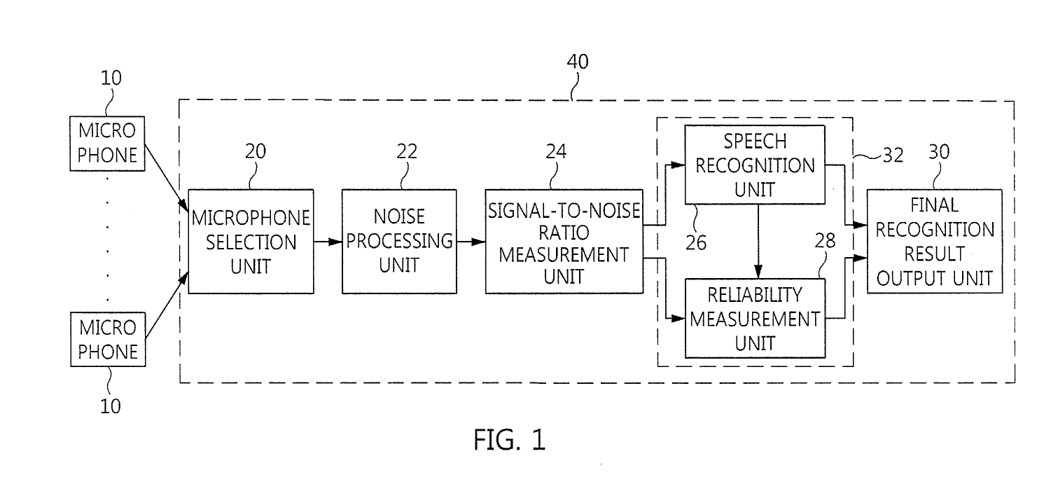

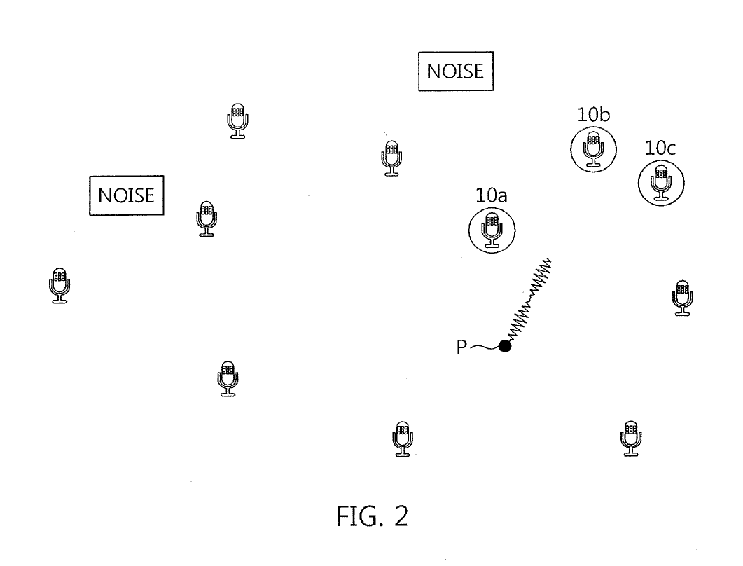

FIG. 1 is a diagram of a configuration of an apparatus for performing asynchronous speech recognition using multiple microphones according to an embodiment of the present invention, and FIG. 2 is a diagram of an example of an arrangement in which a plurality of microphones is distributed and microphones which are responsive to a user's voice.

The apparatus for performing asynchronous speech recognition using multiple microphones according to this embodiment of the present invention includes a microphone selection unit 20, a noise processing unit 22, a signal-to-noise ratio measurement unit 24, a speech recognition and verification unit 32, and a final recognition result output unit 30.

The microphone selection unit 20 measures variations in the energy of a plurality of microphones (for example, the strengths of speech signals) distributed around a user P, as illustrated in FIG. 2. Then the microphone selection unit 20 selects two or more microphones (e.g., the microphones 10a, 10b and 10c) responsive to a user's speech based on the measured variations of the energy of the microphones.

The noise processing unit 22 performs one-channel noise processing on the inputs of the two or more microphones (for example, the microphones 10a, 10b and 10c) selected by the microphone selection unit 20 using a Wiener filter.

The signal-to-noise ratio measurement unit 24 measures the signal to noise ratios of the inputs of the two or more microphones (e.g., the microphones 10a, 10b and 10c) selected by the microphone selection unit 20 and passed through the processing of the noise processing unit 22.

The speech recognition and verification unit 32 performs speech recognition using the input of one microphone which belongs to the selected two or more microphones (for example, the microphones 10a, 10b and 10c) and whose signal to noise ratio is the highest of the signal to noise ratios output by the signal-to-noise ratio measurement unit 24, and verifies the speech recognition using the inputs of the remaining microphones.

The speech recognition and verification unit 32 may include a speech recognition unit 26 and a reliability measurement unit 28. The speech recognition unit 26 performs the speech recognition of the input of the microphone having the highest signal to noise ratio, and outputs one or more word candidates and the probability values of the word candidates for each time span as the results of the speech recognition. The reliability measurement unit 28 measures the reliabilities of one or more word candidates for each time span using the inputs of the remaining microphones other than the microphone having the highest signal to noise ratio.

The final recognition result output unit 30 outputs final recognition results based on the results of the speech recognition and verification unit 32. The final recognition result output unit 30 determines final scores based on the probability values and reliabilities of the one or more word candidates for each time span. Furthermore, the final recognition result output unit 30 may output a word candidate having the highest value for each time span as a final recognition result. That is, the final recognition result output unit 30 may search all the paths of a word lattice, may determine a path having the highest value, and may present the determined path as a final recognition result.

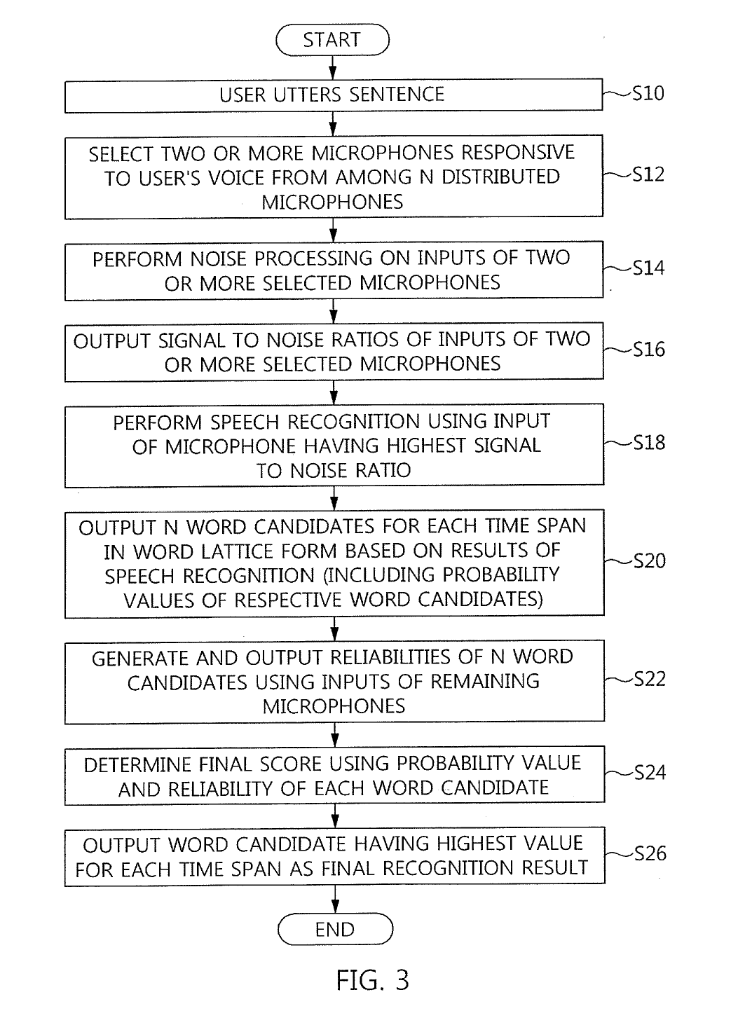

Now, a method of performing asynchronous speech recognition using a plurality of microphones according to an embodiment of the present invention is described with reference to the flowchart of FIG. 3.

In a situation in which N microphones are distributed around a user P and surrounding background noises are input to the microphones, as illustrated in FIG. 2, the user P utters a voice at step S10. The user's voice may be input to each of the microphones.

As a result, the microphone selection unit 20 measures variations in the energy of a plurality of microphones (i.e., the strengths of speech signals) and then selects two or more microphones (e.g., the microphones 10a, 10b and 10c) responsive to the user's speech at step S12. In this case, if the strength of a speech signal is equal to or higher than, for example, the preset strength of a speech signal, it may be considered that a response to the user's voice has been made.

Once the microphones 10a, 10b and 10c have been selected, the noise processing unit 22 performs one-channel noise processing on the input of the selected microphones 10a, 10b and 10c using a Wiener filter or the like at step S14.

Thereafter, at step S16, the signal-to-noise ratio measurement unit 24 measures the signal to noise ratios of the inputs of the microphones on which the noise processing has been performed.

Thereafter, the speech recognition and verification unit 32 performs speech recognition using the input of one microphone which belongs to the selected two or more microphones (for example, the microphones 10a, 10b and 10c) and whose signal to noise ratio is the highest of the signal to noise ratios output by the signal-to-noise ratio measurement unit 24, and verifies the speech recognition using the inputs of the remaining microphones. Referring to FIG. 2, the microphone 10a is a microphone that is far from noise and is closest to the user's voice, and thus the microphone 10a may be a microphone having the highest signal to noise ratio. Accordingly, the speech recognition and verification unit 32 selects the microphone 10a, and performs speech recognition using the microphone 10a.

That is, the speech recognition unit 26 of the speech recognition and verification unit 32 performs the speech recognition of the input of the microphone having the highest signal to noise ratio at step S18. In this case, the speech recognition unit 26 outputs N possible word candidates over time.

The speech recognition unit 26 outputs one or more word candidates and the probability values of the word candidates for each time span as the results of the speech recognition at step S20. In this case, the probability values may be presented using values in the range of 0 to 10.0. A probability value is a numerical representation of the possibility that a speech-recognized word candidate is identical to an actual word at the time at which a voice was uttered.

Meanwhile, the reliability measurement unit 28 of the speech recognition and verification unit 32 measures the reliabilities of the one or more word candidates for each time span using the inputs of the remaining microphones. In this case, the reliabilities may be presented using values in the range of 0 to 1.0. That is, a reliability is a numerical representation of the extent to which a word, that is, a voice, received via the microphones 10b and 10c matches a word candidate obtained by speech-recognizing the input of the microphone 10a for each time span via the speech recognition unit 26. The reliability measurement unit 28 outputs the measured reliabilities of the one or more word candidates for each time span S22.

As described above, the results of speech recognition form a word lattice over time, a probability value of each word candidate is assigned, and then the reliability of each word candidate is obtained through a verification process that is performed using the inputs of the remaining microphones.

Thereafter, the final recognition result output unit 30 determines the final scores of the one or more word candidates based on the probability values and reliabilities of the one or more word candidates for each time span at step S24.

Then the final recognition result output unit 30 outputs a word candidate having the highest value for each time span as a final recognition result. That is, the final recognition result output unit 30 may search all the paths of a word lattice, may determine a path having the highest value, and may present the determined path as a final recognition result at S26.

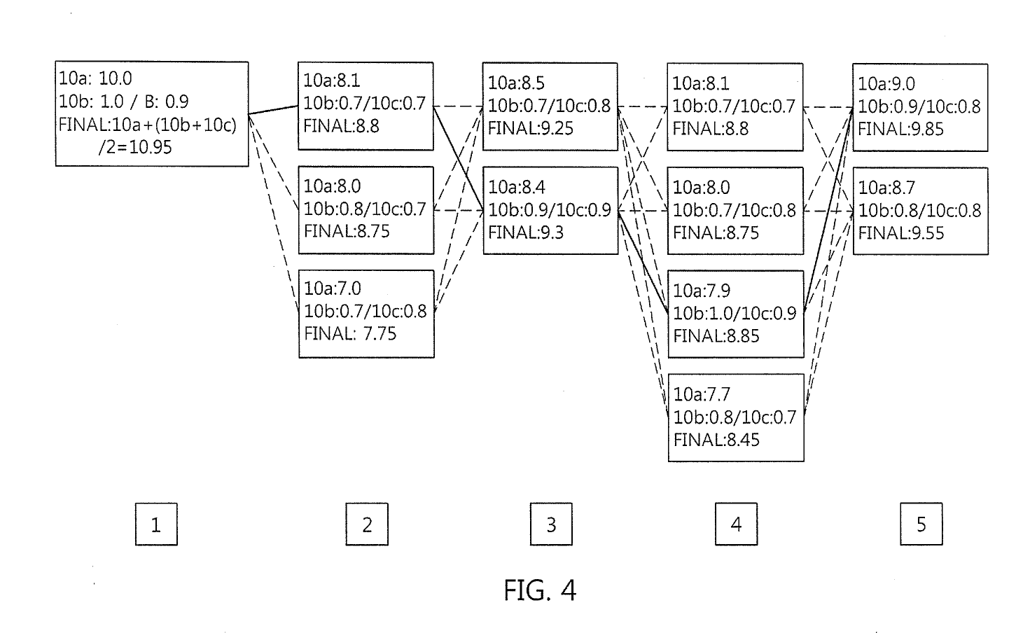

FIG. 4 is a diagram of an example of a word lattice and a final recognition result that are used in the description of embodiments of the present invention. That is, FIG. 4 illustrates a process for determining a path having the highest value in such a manner as to use the inputs of the three microphones 10a, 10b and 10c selected in FIG. 2 and combine a word lattice and probability values obtained from the results of the recognition of the microphone 10a with reliabilities obtained through a verification process using the inputs of the remaining two microphones 10b and 10c, which is performed after the recognition of the microphone 10a.

In the structure of the word lattice of FIG. 4, one or more word candidates are presented for each time span in a direction from the left to the right. In this case, the one or more word candidates for each time span are generated by the speech recognition unit 26.

For example, a case where a user utters the Korean sentence “ [symbol] [symbol] ” is considered. Furthermore, it is assumed that, as a result of the speech recognition of the speech recognition unit 26 for each time span, a single word candidate has been output with respect to “ [symbol] ” in time span 1, three word candidates have been output with respect to “ [symbol] ” in time span 2, two word candidates have been output with respect to “ [symbol] ” in time span 3, four word candidates have been output with respect to “ [symbol] ” in time span 4, and two word candidates have been output with respect to “ [symbol] ” in time span 5. Furthermore, the speech recognition unit 26 outputs the probability values of the respective word candidates for the time spans 1 to 5. In FIG. 4, 10a:10.0, 10a:8.1, 10a:8.0, 10a:7.9, 10a:8.4, 10a:7.7, 10a:9.0, and 10a:7.0 are the probability values of the respective word candidates that are output as a result of the speech recognition of the input of the microphone 10a.

Meanwhile, the reliabilities of the respective word candidates obtained by the reliability measurement unit 28 are represented as 10b:1.0/10c:0.9, 10b:0.7/10c:0.7, 10b:0.8/10c:0.7, 10b:0.7/10c:0.8, 10b:0.9/10c:0.9, 10b:0.9, and 10c:0.8.

In this case, for example, the words in time span 2 may be all connected to the words in time span 3. It will be apparent that words in other adjacent time spans may be connected to each other.

The final recognition result output unit 30 may generate a final score by combining the probability value and reliability of each word candidate with each other. In this case, the final score may be obtained as “10a+(10b+10c)/2,” as illustrated in FIG. 4.

Furthermore, the final recognition result output unit 30 selects a path along which a final score is maximized while tracking all paths from the time span 1 to the time span 5, and then outputs the path as a final recognition result, as illustrated in FIG. 4.

In accordance with at least one embodiment of the present invention, while performance is limited by the number and locations of noises in the case where multiple same characteristic microphones are arranged in a specific structure, performance is not limited by the characteristics of microphones or noises because various types of microphones are distributed.

Furthermore, long distance speech recognition can be performed regardless of the environment because microphones less contaminated with background noise are selected and used to perform speech recognition.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for performing asynchronous speech recognition using multiple microphones, the apparatus comprising:
a microphone selection unit configured to select two or more microphones responsive to a user's voice from among a plurality of microphones distributed around the user;
a signal-to-noise ratio measurement unit configured to measure signal to noise ratios of inputs of the selected two or more microphones;
a speech recognition and verification unit configured to perform speech recognition using the input of the microphone which belongs to the selected two or more microphones and whose signal to noise ratio is highest, and to verify the speech recognition using the inputs of the remaining microphones; and
a final recognition result output unit configured to output final recognition results of the user's voice based on results of the speech recognition and verification unit.

2. The apparatus of claim 1, wherein the speech recognition and verification unit comprises:
a speech recognition unit configured to perform speech recognition of the input of the microphone having the highest signal to noise ratio, and to output one or more word candidates and probability values of the word candidates for each time span as results of the speech recognition; and
a reliability measurement unit configured to measure reliabilities of the one or more word candidates for each time span using the inputs of the remaining microphones.

3. The apparatus of claim 2, wherein the final recognition result output unit determines final scores of the one or more word candidates for the time span based on the probability values and reliabilities of the one or more word candidates for the time span, and outputs a word candidate having a highest value for the time span as one of the final recognition results.

4. The apparatus of claim 1, further comprising a noise processing unit configured to perform noise processing on the inputs of the selected two or more microphones.

5. The apparatus of claim 4, wherein the noise processing unit comprises a Wiener filter.

6. A method of performing asynchronous speech recognition using multiple microphones, the method comprising:
selecting, by a microphone selection unit, two or more microphones responsive to a user's voice from among a plurality of microphones distributed around the user;
measuring, by a signal-to-noise ratio measurement unit, signal to noise ratios of inputs of the selected two or more microphones;
performing, by a speech recognition and verification unit, speech recognition using the input of the microphone which belongs to the selected two or more microphones and whose signal to noise ratio is highest, and verifying, by the speech recognition and verification unit, the speech recognition using the inputs of the remaining microphones; and
outputting, by a final recognition result output unit, final recognition results of the user's voice based on results of the speech recognition and verification unit.

7. The method of claim 6, wherein performing the speech recognition and verifying the speech recognition comprises:
performing speech recognition of the input of the microphone having the highest signal to noise ratio, and outputting one or more word candidates and probability values of the word candidates for each time span as results of the speech recognition; and
measuring reliabilities of the one or more word candidates for each time span using the inputs of the remaining microphones.

8. The method of claim 7, wherein outputting the final recognition results comprises determining final scores of the one or more word candidates for the time span based on the probability values and reliabilities of the one or more word candidates for the time span, and outputting a word candidate having a highest value for the time span as one of the final recognition results.

9. The method of claim 6, further comprising performing, by a noise processing unit, noise processing on the inputs of the selected two or more microphones.
